(19) United States
(12) Patent Application Publication
(10) Pub. No.: US 2012/0244283 A1
(43) Pub. Date: Sep. 27, 2012

(54) METHOD FOR PRODUCING BASEBALL OR SOFTBALL AND MOLD FOR PRODUCING BALL COVER THEREOF

(76) Inventor: Shyi-Ming CHEN, Kaohsiung City (TW)

(21) Appl. No.: 13/188,376

(22) Filed: Jul. 21, 2011

(30) Foreign Application Priority Data
Mar. 25, 2011 (CN) 201110073872.7

(51) Int. Cl. B05D 5/06; A63B 37/02; B29C 45/17

(52) U.S. Cl. 427/256; 425/588; 264/279.1

(57) ABSTRACT

In a baseball or softball shaping method and mold for a ball cover, firstly the ball core is independently formed, thereafter the ball core is placed in the mold cavity of the mold, this mold being constructed from two corresponding figure of 8 shaped soft mold pieces, a joining surface formed where the two mold pieces dock together, and on the inside side of the joining surface, grooves are set to form the raised sewn section on the ball cover and protrusions extend towards the cavity interior for supporting and positioning the ball core, and a material inlet and air outlets set where the two mold pieces join, finally PU material is injected around the ball core placed in the cavity of the ball cover mold to cover the ball core and form the complete ball. Using this invention to produce balls, allows for easy formation of the balls, simplified additional work procedures, greatly increasing the production rate of baseballs and softballs, additionally, utilizing protruding supports to position the ball core followed by forming of the ball cover, together with the air outlets set on the mold, effectively ensures uniform thickness of the ball cover and uniform surface qualities, with precise control over the standards of the ball, for example the pressure resistance values and bounce values, thereby guaranteeing the physical properties of the ball.

### BACKGROUND OF THE INVENTION

1. Field of the Invention

This invention relates to a method for producing a baseball or softball and a mold for producing the ball cover thereof.

2. Description of Related Art

Currently, baseballs and softballs used in formal competitions are mainly constructed from an elastic ball core covered by a leather ball cover. As shown in FIG. 1, this ball cover is made from two figure of 8 shaped pieces A joining at the seams and covering ball core B to form the ball, and the ball covers are sewn at the seams where they meet to form a raised sewn section thus fulfilling the outside appearance of a baseball or softball, this raised sewn section usually being hand-sewn, therefore requiring a higher operational ability of the worker, and in the current environment where labor costs continue to increase, a laborer's work inevitably increases the production cost of the product.

Moreover, the source of leather for the leather ball covers is limited, and leather prices continue to increase, resulting in production costs being difficult to lower and therefore being difficult to raise the competitiveness of the product on the market; additionally, the seams of the two ball covers which are sewn together leave the ball vulnerable to the environment when the ball is used, for example when the ball is used in wet or humid conditions, moisture or water enters through the seams on the ball cover and soaks the ball core, resulting in the ball increasing in weight, and the ball core loosening and therefore the ball changing shape, thereby affecting the elasticity of the ball and no way of ensuring the original physical properties and characteristics of the ball, thus greatly shortening the lifespan of the ball.

Therefore, PU material is used for the ball cover of the ball, as shown in FIG. 2, the two semi circle mold parts 1′, 2′ fit together to form a mold of the ball cover on the ball core; this method can mechanize production of the ball covers to reduce labor production costs, additionally using PU material to replace leather reduces the material costs, at the same time achieving better integrity of the ball cover to improve the waterproofing qualities of the ball, but due to the shape of the mold, after forming the ball a mold line 3′ appears along the center of the ball cover, requiring additional work to trim the ball so as to achieve the required outside appearance of the ball, so drawbacks still remain with the production technique.

Additionally, in the current production method which requires an additional step to complete the ball, problems and drawbacks exist whereby the ball cover integrity and thickness is uneven and air bubbles often appear on the ball cover surface.

### SUMMARY OF THE INVENTION

This purpose of this invention is to provide a way to reduce the production costs of a baseball and softball, with additional work procedures greatly simplified, thereby ensuring uniformity in thickness of the ball cover and surface qualities, through a production method of baseballs and softballs, and a mold to produce the ball covers.

To achieve the above mentioned goals, this invention solves the problems by utilizing the following:

A mold for producing the ball covers of baseballs and softballs, constructed from two corresponding figure of 8 shaped mold pieces, these two mold pieces fitting together to form the ball cover of the ball, these two mold pieces made from a soft material, joining edges formed where the two mold pieces meet, and grooves set on the inside side of the joining edge to form the raised sewn section on the ball cover and protrusions extending towards the inside of the mold cavity being protruding supports to support the ball core, and a material inlet and air outlet set where the two mold pieces join.

A kind of baseball and softball production method has the following steps:

(a) firstly the ball core is independently formed;

(b) then the ball core is placed in the center of the cavity formed where the two corresponding and soft figure of 8 shaped mold pieces join, and at the same time the ball core is held in place by the protruding supports on the interior of the two mold pieces;

(c) thereafter PU material is injected into the mold cavity between the ball core and ball cover which covers the ball core; and

(d) lastly the mold is removed to reveal the complete ball;

In the abovementioned step (a), the ball core is made from PU material, rubber, cork or multilayered yarn. After the abovementioned step (d), spray painting of the raised sewn section in the required colors proceeds.

Utilizing the production method of this invention and the mold to form softballs or baseballs, through the fitting together of two mold pieces to form the complete ball cavity of the ball, the soft mold is easily removed, and moreover, where the two figure of 8 shaped mold pieces join grooves are set to form the raised sewn section on each side of the seam to achieve the required outside appearance of the baseball or softball, the joint lines situated along the formed raised sewn section, thereby omitting the need to trim the ball to achieve the required outside appearance of the ball, the structure of this form shaping mold being simple, meticulously designed, allowing for easy formation of the ball, simplifying additional work procedures, and greatly increasing the production rate of baseballs and softballs; additionally, using the method of protruding supports to position the ball core followed by the formation of the ball cover and the matching of the air outlets on the mold, effectively ensures uniformity in the thickness of the ball cover and uniformity of the surface properties, precise control over the standards of the ball, for example the pressure resistance values and bounce values, thereby ensuring the physical properties and characteristics of the ball.

The invention, as well as its many advantages, may be further understood by the following detailed description and drawings in which:

### BRIEF DESCRIPTION OF THE DRAWINGS

FIG. 1 is an exploded perspective view of a prior art baseball or softball.

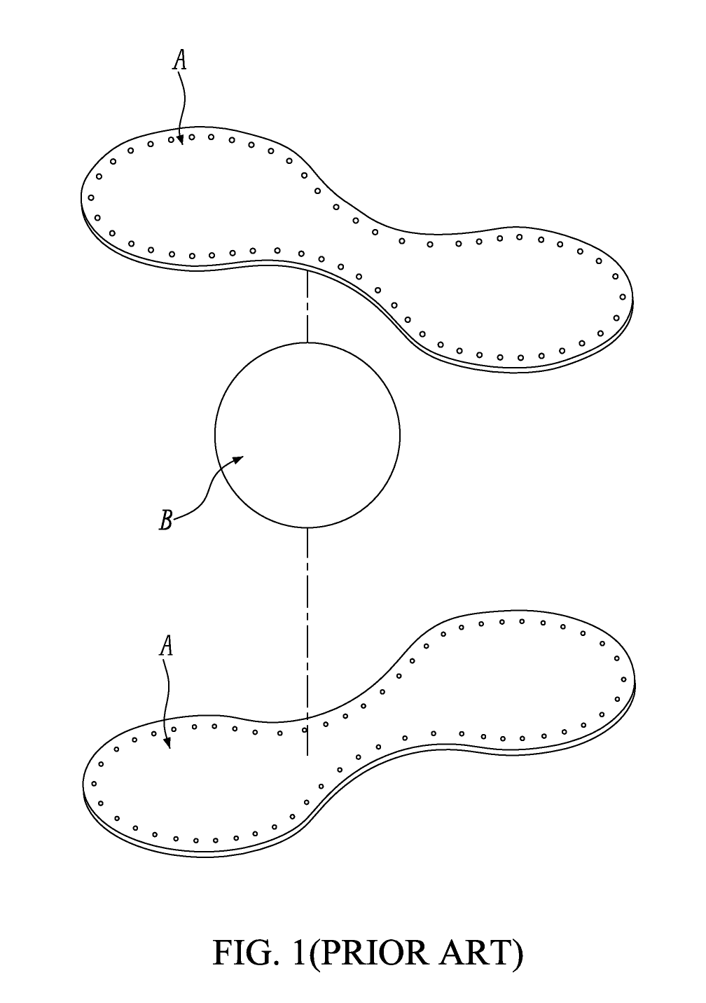

FIG. 2 is a schematic diagram showing the ball cover shaping of a prior art baseball or softball.

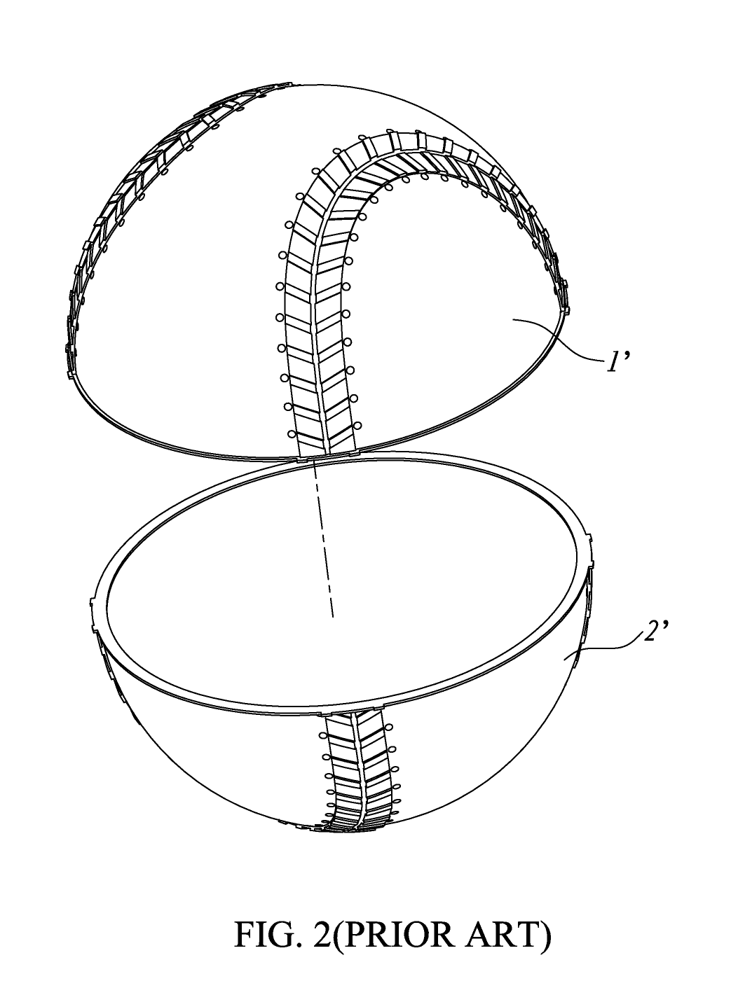

FIG. 3 is a schematic diagram showing the mold structure of the present invention.

FIG. 4 is a schematic diagram showing the embodiment of the mold of the present invention.

FIG. 5 is a diagram showing the shaping process of the present invention.

### DETAILED DESCRIPTION OF THE INVENTION

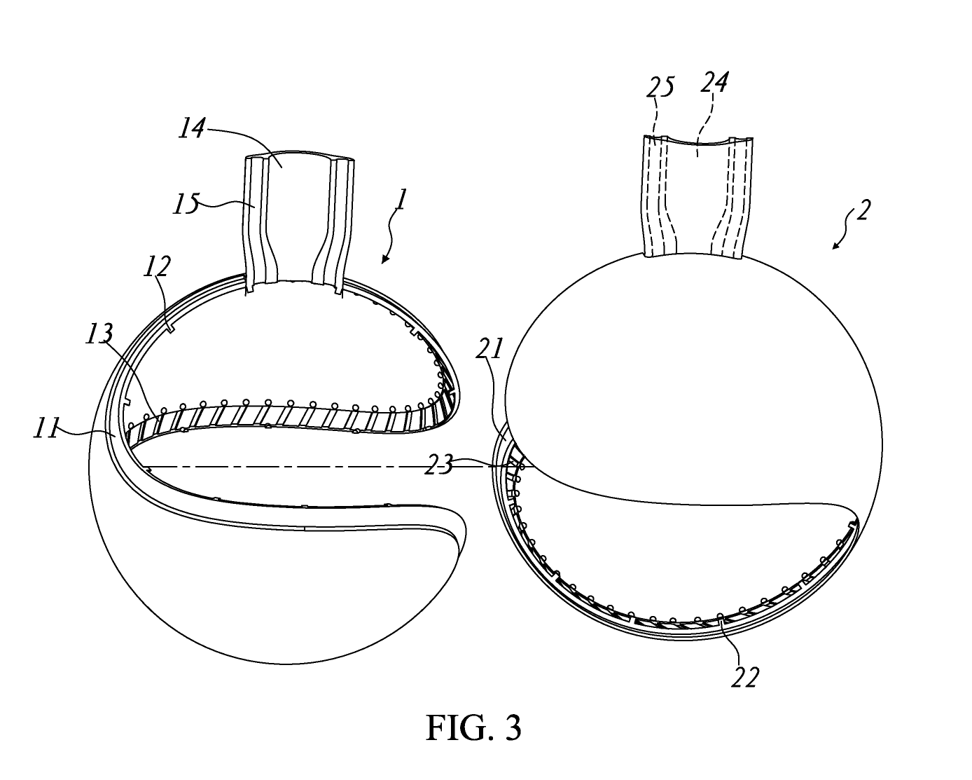

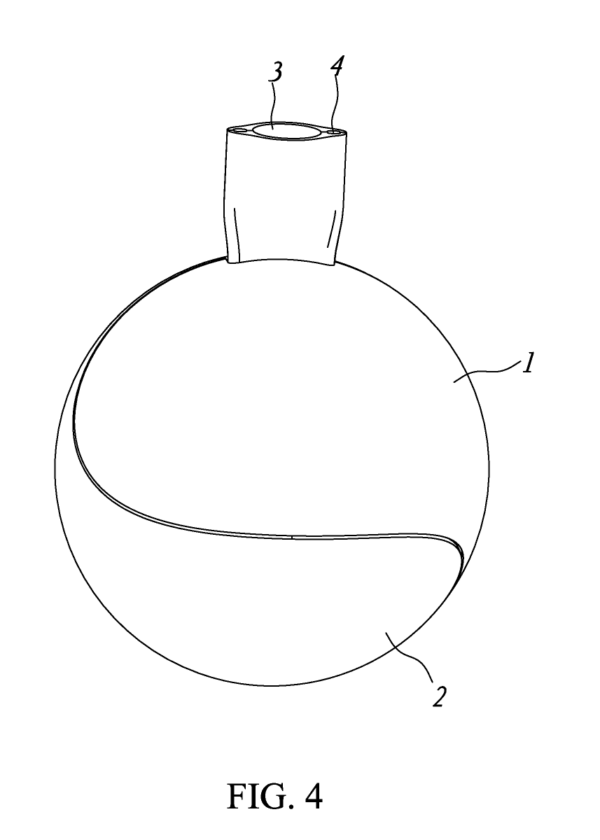

As shown in FIGS. 3 and 4, this invention discloses a production method and ball cover shaping mold of a baseball or softball, this mold constructed from two soft, figure of 8 shaped mold pieces 1, 2 which correspond to the outside appearance of a ball, these two mold pieces 1, 2 fitting together to form the outside appearance of a ball, these two mold pieces 1, 2 able to be made from different materials, for example, rubber, silicone, soft resin and so on.

The boundary of mold piece 1 has a joining edge 11 formed to dock with mold piece 2; on the interior surface of the mold along joining edge 11 positioning protruding supports 12 are set, to cover and support the ball core so as to control the thickness of the ball cover; on the inside side of the interior surface, along joining edge 11 grooves 13 are set to form the raised sewn section on the ball cover; on joining edge 11 of mold piece 1 a protrusion is set having material inlet groove 14 which connects to the inside side of mold piece 1; air outlet grooves 15 are set on two sides of material inlet groove 14 which connect to the inside side of mold piece 1.

On the inside surface on the boundary of mold piece 2 joining edge 21 is formed to match with joining edge 11 on mold piece 1, and when joining edge 21 docks with joining edge 11 on mold piece 1, it forms the same thickness as the mold, and similarly along joining edge 21 on the interior surface on the inside side, positioning protruding supports 22 are set to cover and support the ball core, and along joining edge 21 on the interior surface on the inside side, grooves 23 are set to form the raised sewn section on the ball cover; on joining edge 21 of this mold piece 2 a protrusion is set having material inlet groove 24 which corresponds to material inlet groove 14 and connects to the inside side of mold piece 2; air outlet grooves 25 are set on two sides of material inlet groove 24 which connect to the inside side of mold piece 1.

As shown in FIG. 4, the two mold pieces 1, 2 fit together to form the complete ball and cavity, at the same time material inlet grooves 14, 24 dock together to form material inlet 3, and the two sets of air outlet grooves 15, 25 dock together to form air outlets 4 situated on two sides of material inlet 3.

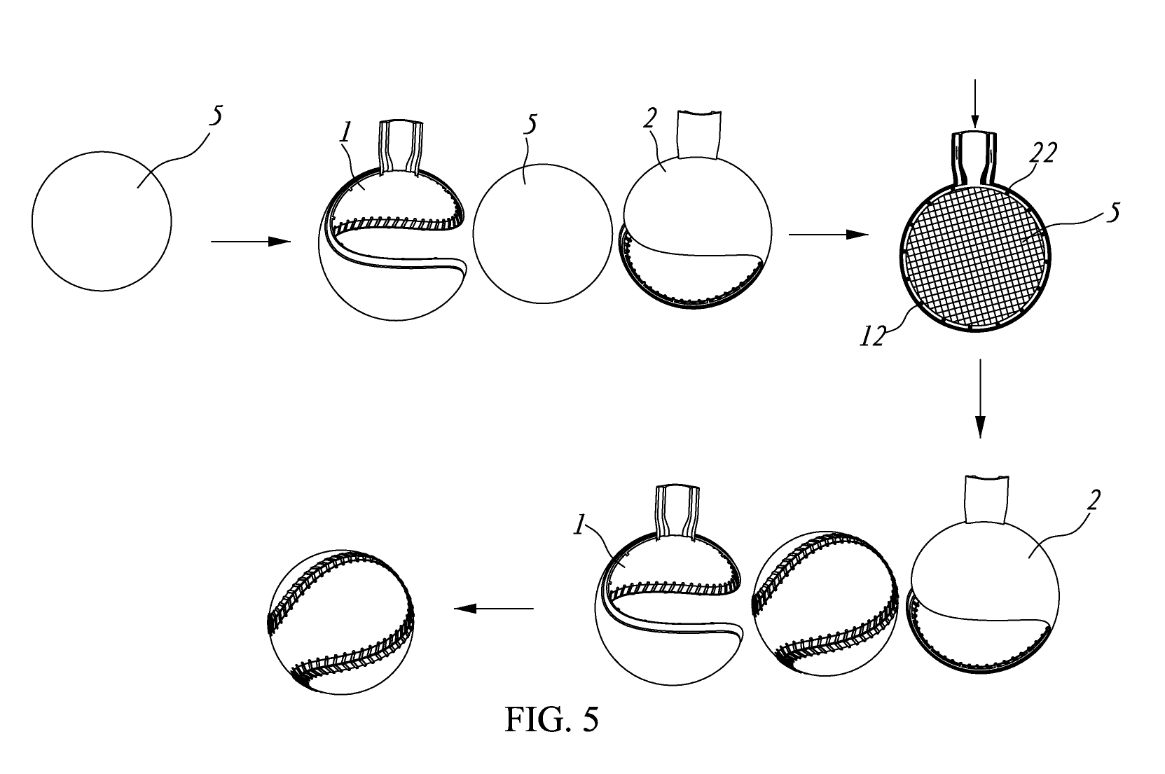

Together with FIG. 5, the production method utilizing the above mentioned mold for baseballs or softballs is as follows.

Firstly, ball core 5 is formed independently; this ball core is one selected from the group consisting of PU, rubber, cork and multilayered yarn.

Thereafter this ball core 5 is placed between the two corresponding figure of “8” shaped soft mold pieces 1, 2 which join together, at the same time ball core 5 is supported in place by protruding supports 12, 22 in the two mold pieces 1, 2.

Thereafter, PU material is injected around ball core 5 and the ball cover to cover the ball core and form the ball cover. Lastly the mold is removed to reveal the complete ball.

To improve the outward appearance of the ball, trimming proceeds around the edges of the material inlet on the surface of the ball, and the formed raised sewn section is spray painted the required colors.

Utilizing the production method of this invention and the mold to form softball or baseball, through the fitting together of two mold pieces to form the complete ball cavity of the ball, the soft mold being easily removed, and moreover, where the two mold pieces dock together grooves are set to form the raised sewn section on the ball cover along where the two mold pieces join so as to achieve the required outside appearance of the baseball and softball, the join lines situated along the formed raised sewn section, thereby omitting the need for trimming to achieve the required outside appearance of the ball, the structure of this form shaping mold being simple, meticulously designed, allowing for easy formation of the ball, simplifying additional work procedures, greatly increasing the production rate of baseballs and softballs; additionally, using the method of protruding supports to position the ball core followed by the formation of the ball cover, and the matching of the air outlets on the mold, effectively ensures uniformity in the thickness of the ball cover and the surface properties, precise control over the standards of the ball, for example the pressure resistance values and bounce values, thereby ensuring the physical properties and characteristics of the ball.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A mold for producing a ball cover of a baseball and softball, characterized in that: the mold is constructed from two corresponding figure of 8 shaped mold pieces, the two mold pieces fitting together to form the ball cover, the two mold pieces made from a soft material, joining edges formed where the two mold pieces meet, and grooves set on an inside side of the joining edge to form a raised sewn section on the ball cover and protrusions extending towards an inside of a mold cavity, the protrusions being protruding supports to support a ball core, and a material inlet and an air outlet set where the two mold pieces join.

2. A method for producing a baseball and softball, comprising the following steps:
(a) firstly a ball core being independently formed;
(b) then the ball core being placed in a center of a mold cavity formed where two corresponding and soft figure of 8 shaped mold pieces join, and at the same time the ball core being held in place by protruding supports on an interior of the two mold pieces;
(c) thereafter PU material being injected into the mold cavity between the ball core and the ball cover which covers the ball core; and
(d) lastly the mold being removed to reveal a complete ball.

3. The method for producing a baseball and softball of claim 2, characterized in that: the ball core is one selected from the group consisting of PU, rubber, cork and multilayered yarn.

4. The method for producing a baseball and softball of claim 2, characterized in that: after the abovementioned step (d), spray painting of a raised sewn section proceeds in the required colors.
